(19) United States
(12) Patent Application Publication
(10) Pub. No.: US 2010/0026380 A1
(43) Pub. Date: Feb. 4, 2010

(54) Reference Generating Apparatus and Sampling Apparatus Thereof

(75) Inventors: Isaac Y. Chen, Hsinchu County (TW); Jin-Lung Kuo, Taoyuan City (TW); Hsin Pang Lu, Jhubei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEMOCOM CORP., Hsin-Chu City (TW)

(21) Appl. No.: 12/182,277

(22) Filed: Jul. 30, 2008

(51) Int. Cl. G05F 3/08

(52) U.S. Cl. 327/544

(57) ABSTRACT

A reference generating apparatus and a sampling apparatus thereof are provided. The coding module is configured to code and decode a first reference signal to retrieve a second reference signal with less power than generating the first reference signal. The second reference signal is identical to the first reference signal in amplitude.

### CROSS-REFERENCES TO RELATED APPLICATIONS

Not applicable.

### BACKGROUND OF THE INVENTION

1. Field of the Invention

The present invention relates to a reference generating apparatus and a sampling apparatus thereof. More particularly, the present invention relates to a reference generating apparatus sampling a first reference signal to retrieve a second reference signal and thus, save power.

2. Descriptions of the Related Art

Many battery-powered portable electronic devices, such as laptop computers, portable digital assistants, digital cameras, cell phones and the like, require ICs devices that provide large storage capacity and low power consumption. To reduce the power consumption and thereby extend the battery life in portable electronic devices, the ICs typically operate under low-power or standby mode when the ICs are not in operation.

Generally, a Bandgap reference circuit is applied for providing a stable reference voltage to the whole circuit. However, the conventional Bandgap reference circuits consume many micro amperes of current due to its configuration, which always conducts current between a high power supply rail and a low power supply rail. However, when the ICs are in a standby mode, the Bandgap reference circuit still draws a relatively large current, which increases the power consumption of the ICs and reduces the battery life of the portable device.

To save power in standby mode, conventional technologies provide several configurations. In one reference of the prior art, a capacitor is applied to store energy and provide voltage when the ICs are in standby mode. However, the capacitor occupies a large area of the die to maintain the electrical charge over a period of time. Besides, the electrical charge of the capacitor may be released to reduce the voltage provided by the capacitor. As a result, using a capacitor for providing voltage is costly and not practical.

In another reference of the prior art, an auxiliary low-accuracy Bandgap reference circuit is applied for providing a voltage in standby mode. The low-accuracy Bandgap reference circuit takes a long time to sample the voltage level that is derived by a high-accuracy Bandgap reference circuit for providing voltage in the active mode. Due to the lengthy sampling of the voltage level, the configuration can only save less power and still consume essential power.

Thus, it is important to provide a reference generating apparatus and a sampling apparatus thereof that can consistently provide a reference signal and save power.

### SUMMARY OF THE INVENTION

The primary objective of this invention is to provide a sampling apparatus. The sampling apparatus is configured to code and decode a first reference signal to retrieve a second reference signal that is identical to the first reference signal in amplitude. The second reference signal is adapted to replace the first reference signal. The sampling apparatus only consumes less power to generate the second reference signal and thus, save power.

To achieve the aforementioned objective, the sampling apparatus comprises a coding module, a memory, and a decoding module. The coding module is configured to sample the first reference signal and generate a coded signal in response to the first reference signal. The memory is configured to store the coded signal. The decoding module is configured to retrieve the coded signal from the memory and decode the coded signal to generate a second reference signal.

Another objective of this invention is to provide a reference generating apparatus. The reference generating apparatus is configured to code and decode a first reference signal to retrieve a second reference signal that is identical to the first reference signal in amplitude, and to output either the first reference signal or the second reference signal in response to the reference selection signal. When the reference generating apparatus outputs the second reference signal, the first reference signal is not generated anymore to save power.

To achieve the aforementioned objective, the reference generating apparatus comprises an initial reference generating circuit, a sampling apparatus, and a multiplexer. The initial reference generating circuit is configured to generate a first reference signal. The sampling apparatus is configured to generate a second reference signal in response to the first reference signal. The multiplexer is configured to receive and output either the first reference signal or the second reference signal in response to the reference selection signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates the reference generating apparatus of the present invention;

FIG. 2 illustrates embodiments of the coding module and the memory of the present invention;

FIG. 3 illustrates an embodiment of the decoding module of the present invention;

FIG. 4 illustrates another embodiment of the decoding module of the present invention; and

FIG. 5 illustrates waveforms of the signals of the present invention.

### DESCRIPTION OF THE PREFERRED EMBODIMENT

In the descriptions that follow, the present invention will be described in reference to the embodiments that describe a reference generating apparatus for coding and decoding a first reference signal to generate a second reference signal with less power consumption to save power. However, embodiments of the invention are not limited to any particular environment, application or implementation. Therefore, the descriptions of the embodiments that follow are for purposes of illustration and not limitation. It is understood that elements indirectly related to the present invention are omitted and are not shown in the following embodiments and drawings.

Unlike the conventional technology, the present invention discloses a reference generating apparatus configured to sample a first reference signal and then generate a second reference signal substantially identical to the first reference signal by coding and decoding. The second reference signal is adapted to replace the first reference signal. Unlike the conventional reference generating circuits that operate in full-time mode, the reference generating apparatus of the present invention is configured to operate in part-time mode to save power.

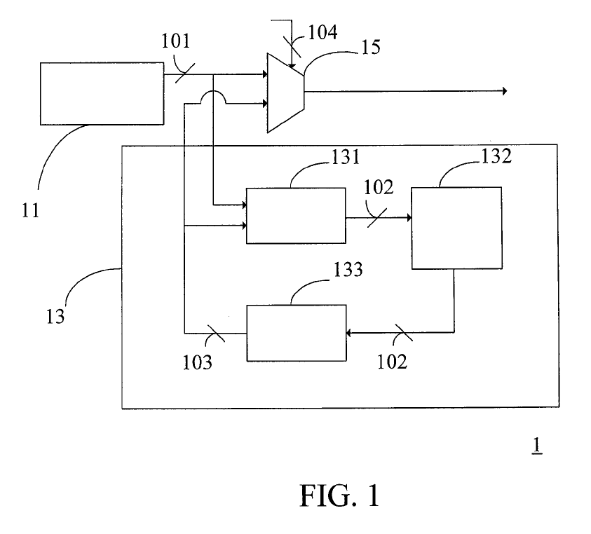

FIG. 1 illustrates a reference generating apparatus 1. The reference generating apparatus 1 is configured to provide a reference signal, such as a reference voltage, for other circuits (not shown) connected to the reference generating apparatus 1. The reference generating apparatus 1 comprises an initial reference generating circuit 11, a sampling apparatus 13, and a multiplexer 15. The initial reference generating circuit 11 is configured to generate a first reference signal 101 to the multiplexer 15 and the sampling apparatus 13. The sampling apparatus 13 then generates a coded signal 102 in response to the first signal 101 and generate a second reference signal 103 by decoding the coded signal 102. The multiplexer 15 is configured to receive and output either the first reference signal 101 or the second reference signal 103 in response to the reference selection signal 104. The second reference signal 103 is substantially identical to the first reference signal 101 in amplitude. That is, when the second reference signal 103 is not yet generated by the sampling apparatus 13, the multiplexer 15 temporarily outputs the first reference signal 101 for continuously providing reference signal to other circuits. When the second reference signal 103 is generated, the multiplexer 15 then mainly outputs the second reference signal 103 as the reference signal to other circuits according to the reference selection signal 104. After the multiplexer 15 outputs the second reference signal 103, the initial reference generating circuit 11 ceases to generate the first reference signal 101 in response to the reference selection signal 104 to save power.

The sampling apparatus 1 comprises a coding module 131, a memory 132, and a decoding module 133. The coding module 131 is configured to sample the first reference signal 101 and generate a coded signal 102 in response to the first reference signal 101. The memory 132 is configured to store the coded signal 102. The decoding module 133 is configured to retrieve the coded signal 102 from the memory 132 and decode the coded signal 102 to generate the second reference signal 103. By storing and decoding the coded signal 102, the sampling apparatus 1 can operate under the part-time mode; that is, the sampling apparatus 1 only consumes power when it operates, and does not continuously consume power for generating a reference signal.

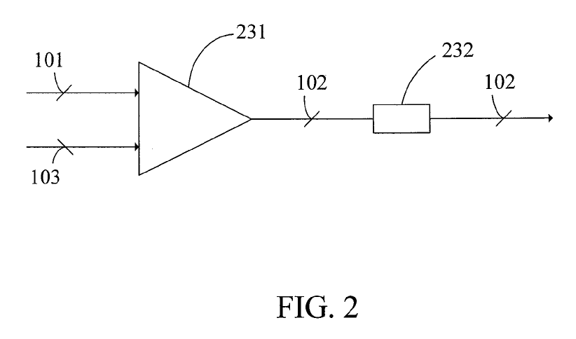

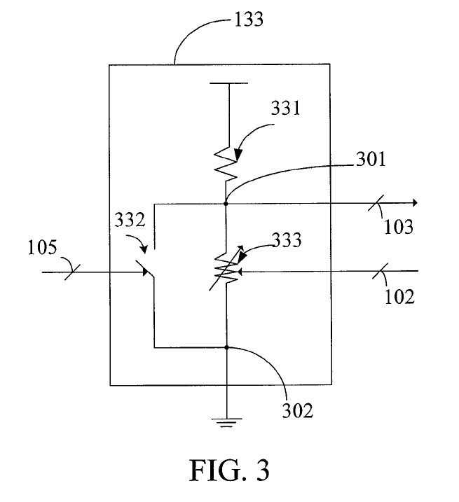

FIG. 2 illustrates the embodiments of the coding module 131 and the memory 132 and the configuration therebetween. Also, FIG. 3 illustrates embodiment of the decoding module 133. Generally, to save power consumption, the coding module 131 is implemented as an Analog-to-Digital converter (ADC), while the decoding module 133 is implemented as a Digital-to-Analog converter (DAC) correspondingly. As shown in FIGS. 2 and 3, the coding module 131 comprises a comparator 231 that is configured to convert the first reference signal 101 into an N-bit digital signal, which is the coded signal 102. The memory 132 is implemented as the N-bit counter 232. The N-bit counter 232 is configured to receive the N-bit digital signal, i.e. the coded signal 102. The decoding module 133 is configured to convert the N-bit digital signal into the second reference signal 103. FIG. 3 illustrates the decoding module 133 that comprises a first resistor 331, a switch 332, and a variable resistor 333.

The comparator 231 is configured to compare the first reference signal 101 and the second reference signal 103. With the circuitry configuration as shown in FIGS. 2 and 3, the second reference signal 103 is smaller than the first reference signal 101 in the very beginning when the comparator 231 receives the first reference signal 101 generated by the initial reference generating circuit 11. The comparator 231 then generates the coded signal 102 indicating the status that the first reference signal 101 is larger than the second reference signal 103. For example, if the first reference signal 101 is provided at the positive terminal of the comparator 231, and the second reference signal 103 is provided at the negative terminal of the comparator 231, the comparator 231 would generate the coded signal 102 in large amplitude. The N-bit counter 232 then counts the coded signal 102 according to the amplitude thereof, and outputs the coded signal 102 to the decoding module 133.

As shown in FIG. 3, the switch 332 and the variable resistor 333 are connected together in parallel to form a first node 301 and a second node 302, while the second node 302 is connected to a low power supply rail, such as the ground shown in FIG. 3. The first resistor 331 is connected to the first node 301 and a high power supply rail. The variable resistor 333 is adapted to vary in response to the N-bit digital signal to generate the second reference signal 103 at the first node, while the switch 332 is adapted to switch on in response to the reset signal 105 to generate a re-coding signal at the first node 301 in place of the second reference signal 103. The detailed description of the operation related to the re-coding signal would be explained later.

The decoding module 133 adjusts the variable resistor 333 according to the amplitude of the coded signal 102. Following the aforementioned conditions, when the first reference signal 101 is larger than the second reference signal 103, the decoding module 133 adjusts the variable resistor 333 so that it has a larger resistance. By applying the voltage divider principle, the second reference signal 103 with larger amplitude is presented at the first node 301. The comparator 231 then compares the first reference signal 101 with the second reference signal 103 with larger amplitude, and outputs the coded signal 102 with amplitude that is not as large as the one in the very beginning when the comparator 231 first receives the first reference signal 101. The N-bit counter 232 then counts the coded signal 102 according to the amplitude thereof, and outputs the coded signal 102 to the decoding module 133. In other words, once the number N of the N-bit counter increases, the N-bit counter 232 can count the coded signal 102 more precisely.

The embodiment of the decoding module 133 shown in FIG. 3 is further configured to generate the re-coding signal to the coding module in response to the reset signal 105. The re-coding signal is adapted to make the coding module re-code the first reference signal 101 to derive a new second reference signal 103. The aforementioned re-coding operation is provided to prevent the second reference signal 103 from error due to a leakage current or undesired power abruption. When the switch 332 is turned on according to the reset signal 105, the first node 301 is connected to the ground while the second reference signal 103 is pulled down to zero level. Then, the comparator 231 detects a differential voltage between the first reference signal 101 and the second reference signal 103 and outputs a coded signal 102 again for generating the second reference signal 103 by the aforementioned operations.

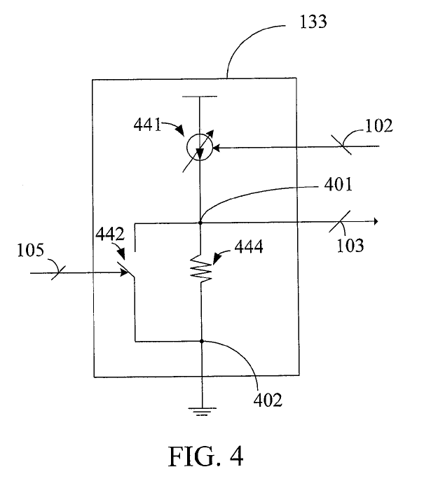

In another embodiment, the decoding module 133 is realized with a current source as shown in FIG. 4.

A switch 442 and a resistor 444 are connected together in parallel to form a first node 401 and a second node 402, while the second node 402 is connected to a low power supply rail, such as the ground shown in FIG. 4. The main difference between the decoding modules shown in FIG. 3 and FIG. 4 is that the decoding module 133 shown in FIG. 4 applies a variable current source 441 instead of the variable resistor 333 shown in FIG. 3. The variable current source 441 is connected to the first node 401 and a high power supply rail. The variable current source 441 is adapted to vary in response to the N-bit digital signal to generate the second reference signal 103 at the first node 401, while the switch 442 is adapted to switch on in response to the reset signal 105 to generate a re-coding signal at the first node 401 in place of the second reference signal 103. The detailed description of the operation related to the re-coding signal would be explained later.

The decoding module 133 adjusts the variable current source 441 according to the amplitude of the coded signal 102. When the first reference signal 101 is larger than the second reference signal 103, the decoding module 133 adjusts the variable current source 441 to generate a larger current. As the larger current flowing through the resistor 444, the second reference signal 103 with larger amplitude is presented at the first node 401. The second reference signal 103 is then applied in the sampling apparatus 1 as aforementioned, and redundant description is omitted hereinafter.

In the embodiment shown in FIG. 1, the initial reference generating circuit 11 is a Bandgap reference circuit that is configured to generate a Bandgap reference signal, such as a Bandgap reference voltage. After the second reference signal 103 is generated, the reference selection signal 104 is provided to the multiplexer 15, while the multiplexer 15 mainly outputs the second reference signal 103 as the reference signal to other circuits. Then, the initial reference generating circuit 11 enters the rest mode and no longer generates the first reference signal 101 to save power. By coding and decoding the first reference signal 101 to generate the second reference signal 103, the reference generating apparatus can save power. Typically, the ADC converter and the DAC converter shown in FIGS. 2 and 3 may only consume less than 10 micro amperes per second, referring to the Bandgap reference circuit of the conventional technology that usually consumes many micro amperes.

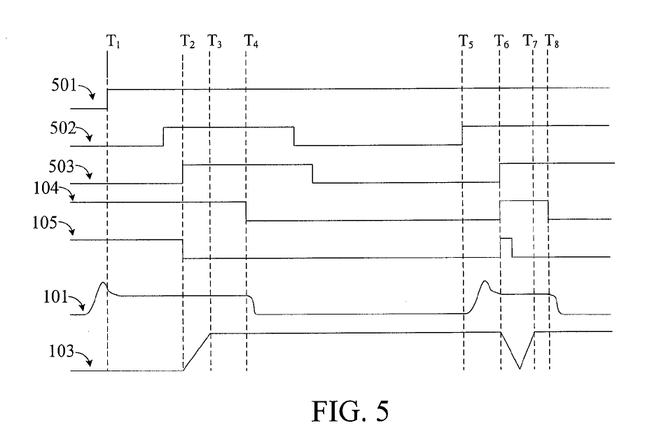

FIG. 5 illustrates several waveforms of the aforementioned signals of the present invention and waveforms of the other circuits in associated with the present invention for explaining the operations of the present invention. The power-on signal 501 shows that the whole circuitry included in the present invention is ready to work when the power-on signal 501 is turned to the high level. An active signal 502 denotes that at least part of the whole circuitry is operating when the active signal 502 turns to the high level. When the active signal 502 turns to the low level, the whole circuitry stays in the standby mode, i.e. the whole circuitry does not operate but is ready to operate without restarting the whole circuitry. The sampling enable signal 503 denotes the sampling apparatus 13 starts to operate when the sampling enable signal 503 turns to the high level.

Before the power-on signal 501 turns to the high level at time T1, the first reference signal 101 is generated and stays in a stable level, as shown in FIG. 5. After the active signal 502 turns to the high level, at time T2, the sampling apparatus 13 starts to sample the first reference signal 101 and generate the second reference signal 103. It takes a period of time from time T2 to T3 for the sampling apparatus 13 to make the second reference signal 103 stay at the desired level, as shown in FIG. 5. Particularly, at time T2, the reset signal 105 is adapted to turn to the low level for turning on the switch 332 to ensure that the sampling apparatus 13 samples the first reference signal 101. After time T3, the initial reference generating circuit can cease to generate the first reference signal 101. In this embodiment, the initial reference generating circuit ceases to generate the first reference signal 101 in response to the reference selection signal 104 at time T4.

The operation of re-coding the first reference signal is illustrated in the period of time from time T5 to T8. At time T5, the initial reference generating circuit 11 generates the first reference signal 101. After a period of time from time T5 to T6, the first reference signal 101 stays at a stable level, then the reset signal 105 is excited to be high in response to the rising edge of the sampling enable signal 503 at time T6. The reset signal 105 is adapted to turn on the switch 332 and to generate the re-coding signal at the first node in place of the second reference signal 103, i.e. the second reference signal 103 turns to the low level. Then, the sampling apparatus 13 re-codes the first reference signal 101 to derive a new second reference signal 103 at time T7. The multiplexer 15 then outputs the second reference signal after time T7. At time T8, the reference selection signal 104 turns to the low level to cease the generation of the first reference signal 101.

The present invention samples the first reference signal then generates the second reference signal by coding and decoding operations. Therefore, the present invention can cease to generate the first reference signal and replace the first reference signal with a decoded signal, for example a digital signal, to save power.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A sampling apparatus comprising:
a coding module being configured to sample a first reference signal and generate a coded signal in response to the first reference signal;
a memory being configured to store the coded signal; and
a decoding module being configured to retrieve the coded signal from the memory and decode the coded signal to generate a second reference signal;
wherein the second reference signal is substantially identical to the first reference signal in amplitude.

2. The sampling apparatus as claimed in claim 1, wherein the coding module is an Analog-to-Digital converter (ADC), and the decoding module is a Digital-to-Analog converter (DAC), the coding module converts the first reference signal into a N-bit digital signal, and the decoding module converts the N-bit digital signal into the second reference signal.

3. The sampling apparatus as claimed in claim 2, wherein the coding module comprises a comparator, and the memory is a N-bit counter, the comparator compares the first reference signal and the second reference signal to generate an output signal, the N-bit counter generates the N-bit digital signal in response to the output signal.

4. The sampling apparatus as claimed in claim 2, wherein the decoding module is further configured to generate a re-coding signal to the coding module in response to a reset signal, and the coding module samples the first reference signal in response to the re-coding signal.

5. The sampling apparatus as claimed in claim 4, wherein the decoding module comprises a first resistor, a switch, and a variable resistor, in which:
the switch and the variable resistor are connected together in parallel to form a first node and a second node, and the second node is connected to a low power supply rail;
the first resistor is connected to the first node and a high power supply rail; and
the variable resistor is adapted to vary in response to the N-bit digital signal to generate the second reference signal at the first node, and the switch is adapted to switch on in response to the reset signal to generate the re-coding signal at the first node in replace of the second reference signal.

6. The sampling apparatus as claimed in claim 4, wherein the decoding module comprises a resistor, a switch, and a variable current source, in which:
the switch and the resistor are connected together in parallel to form a first node and a second node, and the second node is connected to a low power supply rail;
the variable current source is connected to the first node and a high power supply rail; and
the variable current source is adapted to vary in response to the N-bit digital signal to generate the second reference signal at the first node, and the switch is adapted to switch on in response to the reset signal to generate the re-coding signal at the first node in replace of the second reference signal.

7. A reference generating apparatus, comprising:
an initial reference generating circuit, being configured to generate a first reference signal;
a sampling apparatus, comprising:
a coding module being configured to sample the first reference signal and generate a coded signal in response to the first reference signal;
a memory being configured to store the coded signal; and
a decoding module being configured to retrieve the coded signal from the memory and decode the coded signal to generate a second reference signal; and
a multiplexer, being configured to receive and output one of the first reference signal and the second reference signal in response to a reference selection signal;
wherein the second reference signal is substantially identical to the first reference signal in amplitude.

8. The reference generating apparatus as claimed in claim 7, wherein the coding module is an Analog-to-Digital converter (ADC), and the decoding module is a Digital-to-Analog converter (DAC), the coding module converts the first reference signal into a N-bit digital signal, and the decoding module converts the N-bit digital signal into the second reference signal.

9. The reference generating apparatus as claimed in claim 8, wherein the coding module comprises a comparator, and the memory is a N-bit counter, the comparator compares the first reference signal and the second reference signal to generate an output signal, the N-bit counter generates the N-bit digital signal in response to the output signal.

10. The reference generating apparatus as claimed in claim 8, wherein the decoding module is further configured to generate a re-coding signal to the coding module in response to a reset signal, and the coding module samples the first reference signal in response to the re-coding signal.

11. The reference generating apparatus as claimed in claim 10, wherein the decoding module comprises a first resistor, a switch, and a variable resistor, in which:
the switch and the variable resistor are connected together in parallel to form a first node and a second node, and the second node is connected to a low power supply rail;
the first resistor is connected to the first node and a high power supply rail; and
the variable resistor is adapted to vary in response to the N-bit digital signal to generate the second reference signal at the first node, and the switch is adapted to switch on in response to the reset signal to generate the re-coding signal at the first node in replace of the second reference signal.

12. The reference generating apparatus as claimed in claim 10, wherein the decoding module comprises a resistor, a switch, and a variable current source, in which:
the switch and the resistor are connected together in parallel to form a first node and a second node, and the second node is connected to a low power supply rail;
the variable current source is connected to the first node and a high power supply rail; and
the variable current source is adapted to vary in response to the N-bit digital signal to generate the second reference signal at the first node, and the switch is adapted to switch on in response to the reset signal to generate the re-coding signal at the first node in replace of the second reference signal.

13. The reference generating apparatus as claimed in claim 7, wherein the initial reference generating circuit is a Bandgap reference circuit being configured to generate a Bandgap reference signal.

14. The reference generating apparatus as claimed in claim 7, wherein the initial reference generating circuit ceases to generate the first reference signal in response to the reference selection signal.
